(19) United States
(12) Patent Application Publication
(10) Pub. No.: US 2003/0024872 A1
(43) Pub. Date: Feb. 6, 2003

(54) Filter having staged pleating

(75) Inventors: Tom Muzik, Thousand Oaks, CA (US); Kevin Knebel, Simi Valley, CA (US); Alex Vinarov, Moorpark, CA (US)

Correspondence Address: Eric S. Chen, PILLSBURY WINTHROP LLP, Suite 2800, 725 South Figueroa Street, Los Angeles, CA, 90017-7100, US

(73) Assignee: PTI Advanced Filtration, Inc.

(21) Appl. No.: 10/254,713

(22) Filed: Sep. 25, 2002

Related U.S. Application Data
(63) Continuation-in-part of application No. 09/608,076, filed on Jun. 30, 2000, now abandoned.
Application No. 09/608,076 is a continuation-in-part of application No. 09/345,213, filed on Jun. 30, 1999, now abandoned.

(51) Int. Cl. B01D 27/06

(52) U.S. Cl. 210/457; 210/490; 210/493.1; 210/484

(57) ABSTRACT

The present invention relates to a novel filter element having a septum with a staged pleating that repeats a pleating sequence having a major (longest) pleat, a minor (shortest) pleat and at least one intermediate pleat therebetween. The intermediate pleat(s) have pleat heights that are evenly distributed within the range of pleat heights bounded by the pleat height of the minor pleat and the pleat height of the major pleat. In two particular embodiments of the invention, the pleat height ratios of the major, intermediate and minor pleats are 3:2:1 and 4:3:2:1. In an filter element, the pleated septum may be held between an inner core and an outer guard. The tip of the major pleat in each pleating sequence may be in contact with the inner core of the filter element. The septum may also include drainage layers on upstream and downstream of the filter material layer.

### CROSS-REFERENCE TO RELATED APPLICATION

This application is a continuation-in-part of U.S. patent application Ser. No. 09/608,076, filed Jun. 30, 2000, which is a continuation-in-part of U.S. patent application Ser. No. 09/345,213, filed Jun. 30, 1999, the disclosure of which is incorporated herein by reference.

### BACKGROUND

The present invention relates to filters, and more particularly to pleated filter elements and filter assemblies including pleated filter elements.

In order to remove contaminants from a flowing gas or liquid, filter elements and assemblies have heretofore been used which cause the medium to be filtered to pass through a filter material. In many of these filter elements, the filter material is in the form of a flat sheet. However, in some filter elements, the filter material has been pleated. As compared to filter elements in which the filter material is flat, pleated filter elements offer an increased filter surface area without substantially increasing the overall size and weight of the filter element.

Generally, in pleated filter elements, the size of the pleats has been uniform, i.e. only one pleat size has been used in a particular filter element. Such pleated filter elements may be formed into various shapes by spacing the pleats around a core element having that shape. However, supporting a filter element around a core element has the disadvantage of reducing the filter surface area available for contaminant removal.

### SUMMARY OF THE INVENTION

The present invention relates to a novel filter element having a septum with staged pleating in which the heights of successive pleats are related by a specified ratio as well as to a filter assembly incorporating such a filter element. Two particular pleat height ratios are discussed. Pleat sequences according to the pleat height ratios may be repeated about the perimeter of a desired inner core. The septum may also include drainage layers on upstream and downstream of the filter material layer.

### BRIEF DESCRIPTION OF THE DRAWINGS

FIG. 1 depicts a three-pleat pleating sequence according to an embodiment of the present invention.

FIG. 2 depicts a four-pleat pleating sequence according to an embodiment of the present invention.

FIG. 2A generally depicts a multi-pleat pleating sequence according to an embodiment of the present invention.

FIG. 3 shows a cylindrical filter element incorporating a pleating pattern based on a pleating sequence according to the present invention.

FIG. 3A shows a cross-section of the cylindrical filter element shown in FIG. 3 taken across the line “A”-“A.”

FIG. 3B shows a portion of the septum shown in FIG. 3A.

### DETAILED DESCRIPTION

The present invention relates to filter elements and assemblies that may be used in applications where higher filtration flow rates, lower retention

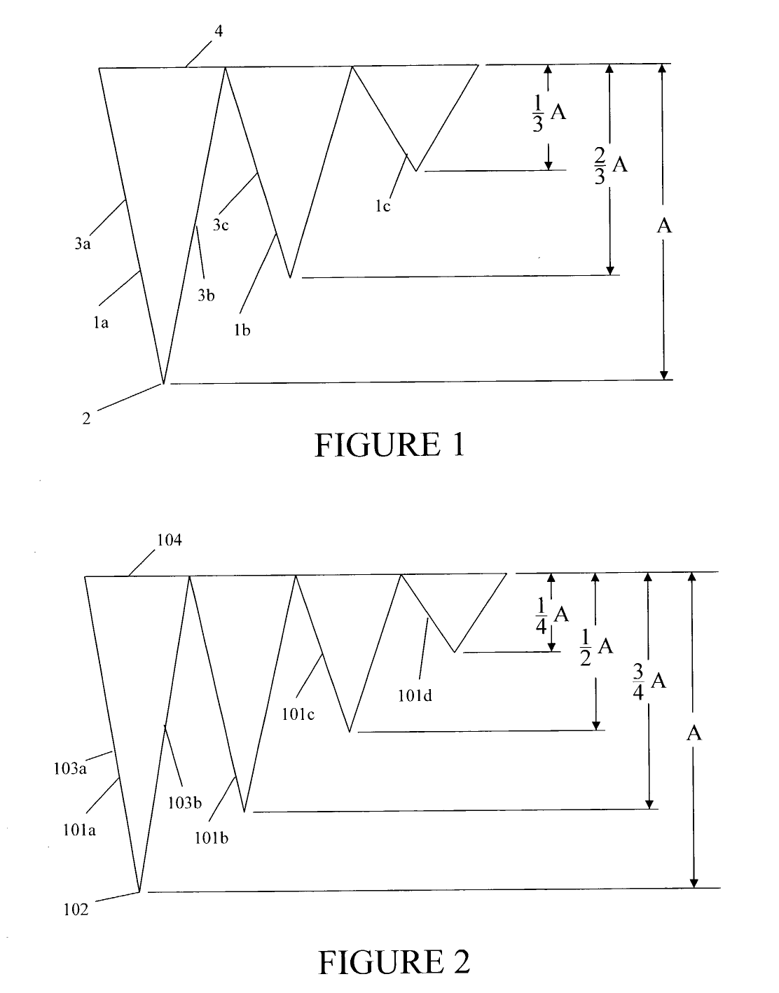

FIG. 1 shows a three-pleat pleating sequence according to an embodiment of the present invention. The pleating sequence consists of a major pleat 1a and two minor pleats 1b and 1c (collectively “pleats 1”). Each pleat has two sides 3a and 3b. The pleats 1 may be made of a single- or multi-layer septum material which includes as a layer a filter material. An example of a suitable filter material is a polytetrafluoroethylene (PTFE) material produced by W. L. Gore & Associates of Newark, Del. The pleat height of any, pleat in the sequence is measured as the shortest straight-line distance from the pleat's base 4 to the pleat's tip 2. In a pleating sequence according to the three-pleat embodiment of the present invention shown in FIG. 1, the pleat height of the major pleat 1a is shown as “A.” The pleat heights for the minor pleats 1b and 1c are ⅔ of A and ⅓ of A respectively. Therefore, the pleat height ratio for the pleating sequence is 3:2:1. The width of the base 4 for each pleat may be substantially the same and may be determined by the thickness of the single- or multi-layer septum material. Pleats 1 may be formed using a microprocessor-controlled knife pleater such as the Accordion Pleating Machine Model #R178PC manufactured by Karl Rabofsky GmbH.

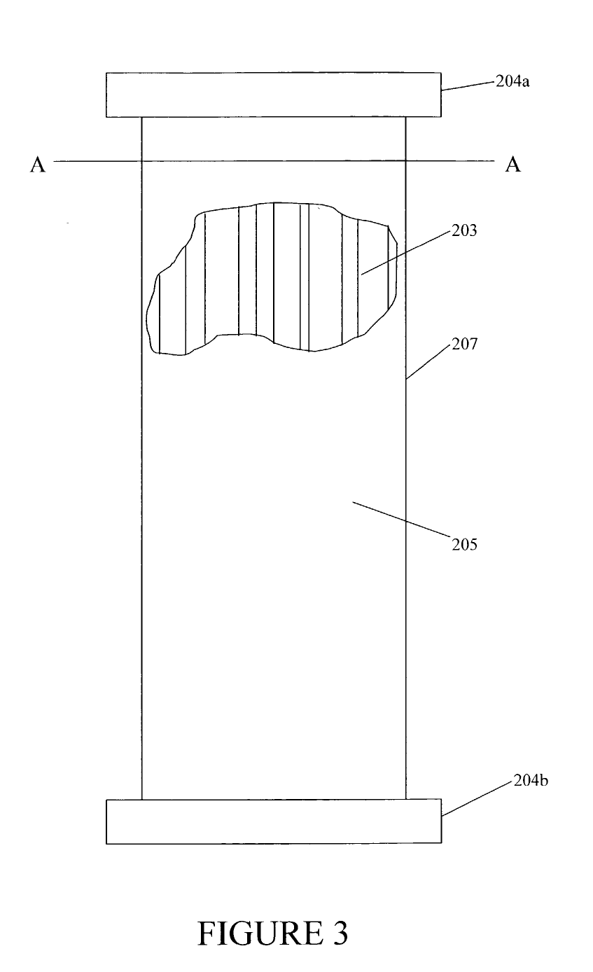

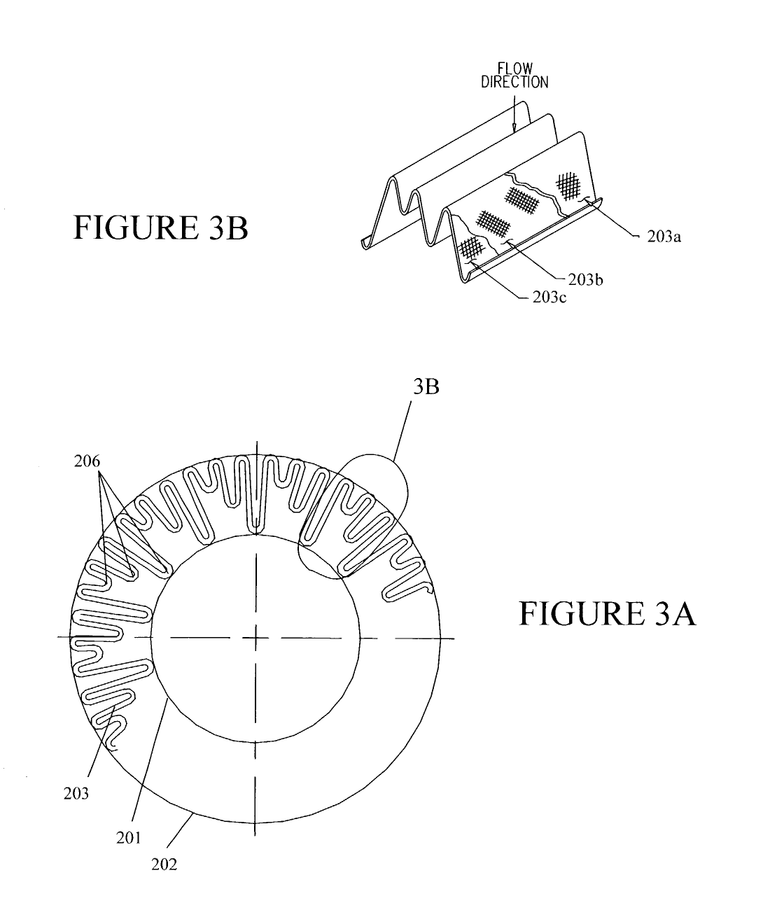

Although the tip 2 of each pleat is shown as a point, giving the pleat a “V” shape, the tip actually may be slightly rounded. The radius of the tip 2 may be determined by the characteristics of the implement used to create the pleats 1 in a sheet of filter material as well as the thickness of the filter material sheet. In embodiments of the invention, the pleat material may consist of multiple sheets. For example, the filter material sheet may be placed between drainage layer sheets. An embodiment including multi-layer pleats is discussed in greater detail in relation to FIG. 3B.

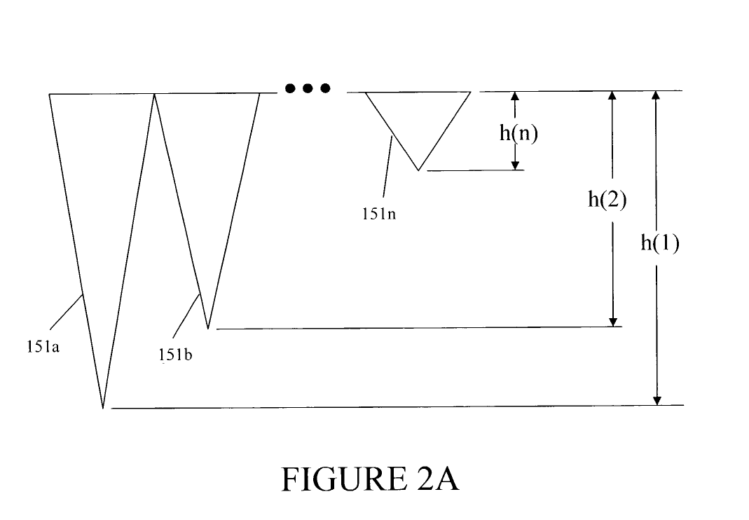

FIG. 2 shows a four-pleat pleating sequence according to an embodiment of the present invention. As in the embodiment shown in FIG. 1, the pleating sequence has a major pleat 101a. The pleating sequence also has three minor pleats 101b, 101c and 101d. Each pleat has two sides 103a and 103b. The pleat height of any pleat in the sequence is measured as the shortest straight-line distance from the pleat's base 104 to the pleat's tip 102. In a pleating sequence according to the three-pleat embodiment of the present invention shown in FIG. 1, the pleat height of the major pleat 101a is shown as “A.” The pleat heights for the minor pleats 101b, 101c and 101d are ¾ of A, ½ of A and ¼ of A respectively. Therefore, the pleat height ratio for the pleating sequence is 4:3:2:1. The width of the base 104 for each pleat may be substantially the same and may be determined by the thickness of the septum material.

FIG. 2A generally depicts multi-pleat pleating sequences according to embodiments of the present invention. A pleating sequence may have an integral number of pleats, n, with pleat heights ranging from that of the minor pleat 151n to that of the major pleat 151a, with n−1 intermediate pleats with pleat heights evenly distributed therebetween. The pleat height of the major pleat 101a may be determined by the inner and outer diameters of the filter element (i.e., the diameters of the inner core 201 and outer guard 202). These diameters may in turn be determined by the application in which the filter assembly is being used. For example, the maximum diameter of the outer guard 202 may be limited by spatial constraints imposed by the apparatus by which fluid is transported to and from the filter assembly. The diameter of the inner core 201 may similarly be dictated by the size of inlet and/or outlet ports through which the fluid is received by and/or removed from the filter assembly and may be selected based upon a number of application-specific factors such as the desired or required efficiency rating, flow rate, viscosity, and/or operating temperature span.

According to embodiments of the invention, the major pleat 151a may extend from the outer guard 202 to the inner core 201, with the base of the major pleat 151a being located along the outer diameter of the filter element (i.e., proximate the outer guard 202) and the tip of the major pleat being in contact with the inner core 201. As a result, the pleat height of the major pleat may be approximately equal to half the difference between the diameters of the inner core 201 and the outer guard 202. The height of an ith intermediate pleat between the major pleat 151a (for which i=1) and the minor pleat 151n (for which i=n) may be determined by the following formula:

h(i)−h(1)−((i−1)*((h(1)−h(n))/(n−1)));

where

h(1)=height of the major pleat, and

h(n)=height of the minor pleat.

Thus for a four-pleat pleating sequence in a filter element with an outer guard 202 diameter of 2.52 inches, an inner core 201 diameter of 1.16 inches and a minor pleat height, h(4), of 0.38 inches, the pleat heights for the various pleats may be calculated to be approximately:

Dₒ=Diameter of the outside=2.52 inches

Dᵢ=Diameter of the inside=1.16 inches

X=Number of Pleating Stages=4

h(0)=pleat height of minor pleat=0.38 inches (WE HAVE NOT ADDRESS HOW WE DETERMINE HOW THE MINOR PLEAT IS GENERATED. IS THAT A PROBLEM? I CAN STATE GENERALITIES, BUT IT IS REALLY A TRIAL AND ERROR PROCESS TO DIAL IT IN.)

h(1)=pleat height of major pleat=(Dₒ−Dᵢ)/2=(2.52−1.16)/2=0.68 inches

h(2)=pleat height of first intermediate pleat=0.38+((2−1)*((0.68−0.38)/(4−1)))=0.48 inches

h(3)=pleat height of second intermediate pleat=0.38+((3−1)*((0.68−0.38)/(4−1))) =0.58

It shall be appreciated that the actual height of a pleat may vary due to variable in the pleating process, such as the thickness of the septum material(s), the radius of the edge against which the septum material is pleated (where, for example, a knife pleater is used), manufacturing tolerances associated with the pleating machinery, and the like. Hence, it is likely that in any septum pleated to produce the described pleating sequences, the actual pleat heights will vary somewhat from the calculated values.

As shown in FIG. 3, a filter assembly according to an embodiment of the present invention may also include an end cap 204a and 204b at each end of the filter element 207 (shown in FIG. 3A). In embodiments of the invention, the end caps 204a and 204b may be attached to the septum 203, inner core 201 and/or outer guard 202 by methods of attachment suitable to the materials being used, the medium being filtered, the contaminant being removed, and other application-specific considerations. For example, in different applications, the end caps 204a and 204b may be attached using one or more of the following: adhesives or epoxy; thermal, diffusion or ultrasonic welding; or mechanical fasteners. It may be desirable to attach the end caps 204a and 204b to the ends of the filter element in such a way as to create a seal that prevents leakage of the medium being filtered. The filter element 207 may also be encased in an outer support tube 205. The portion of the outer support tube 205 and outer guard 202 have been cut away in FIG. 3 to display the pleated septum 203 therein.

FIG. 3A shows a cross-section of the filter assembly illustrated in FIG. 3. The filter element may have an inner core 201 and an outer guard 202. The pleating sequence 206 may be repeated around the inner core 201 to form the septum 203. In particular, FIG. 3A shows an embodiment in which the septum 203 is formed using a pleating sequence 206 having three pleats with a height ratio of 3:2:1, similar to the pleats 2 shown in FIG. 1. Only a portion of the septum 203 is shown in FIG. 3A; in embodiments of the present invention, the pleating sequence may be repeated such that the septum 203 completely surrounds the inner core 201.

A portion of a multi-layer embodiment of the septum 203 shown in FIG. 3 is depicted in FIG. 3B. As shown, the medium being filtered flows from the side of the septum 203 proximate the outer guard 202 (the “upstream side”), to the bottom side of the septum 203 proximate the inner core 201 (the “downstream side”). In alternative embodiments, the flow direction may be reversed, i.e., the upstream side of the septum 203 may be proximate the inner core 201 and the downstream side of the septum 203 may be proximate the outer core 202. The septum 203 may include an upstream drainage layer 203a, a filter material layer 203b and a downstream drainage layer 203c. In FIG. 3B, the upstream drainage layer 203a has been cut away to expose the filter material layer 203b and the filter material layer 203b has been cut away to expose the downstream drainage layer 203c. The upstream and downstream drainage layers 203a and 203c may be made of a woven or non-woven material with good porosity, such as glass, natural fibers, or polymeric materials (e.g., polyester, polypropylene or a polyamide) and may be in the form of an extruded mesh. Although the upstream and downstream drainage layers 203a and 203c are referred to as “drainage” layers, they may serve a structural support function in addition to or in place of their drainage function.

In other embodiments of the present invention, the septum 203 may not include upstream and downstream drainage layers 203a and 203c. Alternatively, the septum 203 may include additional layers. For example, the septum 203 may include a pre-filtering layer placed upstream of the filter material layer. The purpose of the pre-filter layer may be to remove contaminants larger than the contaminants the filter material layer 203b is designed to remove from the medium. Removal of these larger contaminants by a pre-filter layer may reduce clogging or obstruction of the filter material layer 203b. In an embodiment of the present invention, a upstream drainage layer 203a may also serve as a pre-filter layer.

In an embodiment of the invention, the septum 203 may include spacing elements on the surface of the upstream side, the downstream side or both of the septum 203. The spacing elements may be placed so that spacing elements on adjacent pleats interfere or make contact when the adjacent pleats are moved together. Using the pleats 2 in FIG. 1 as an example, spacing elements placed on leg 3b of major pleat 1a may interfere with spacing elements on leg 3c of minor pleat 1b. The spacing elements may be sufficiently spaced apart and of such size as to not significantly reduce the filtering area of the septum 203.

The filter element may have a circular inner core 201 and/or outer guard 202. However, in embodiments of the invention, the inner core 201 and the outer guard 202 may be rectangular or have different shapes. In an embodiment of the invention, the inner core 201 may have a different shape from the outer guard 202.

The septum may be created by pleating a sheet of filter material (and sheets of drainage layer material and/or sheets of material for other layers of a multi-layer septum), wrapping the sheet(s) into the shape required to fit around the perimeter of the inner core 201, and side-sealing the ends of the sheet(s). The sides may be sealed using an adhesive or epoxy; diffusion, ultrasonic or thermal welding; mechanical fasteners or the like.

The inner core 201 and/or outer guard 202 may be formed from extruded polypropylene mesh, a metallic mesh or the like. The material forming the inner core 201 and outer guard 202 may be chosen based on the nature of the medium being filtered, the contaminant being removed, the thermal environment for the filtering application or similar considerations. For example, in high temperature applications, it may be necessary to use a metallic mesh inner core 201 and outer guard 202. The filter element may be used for inside-out flow, in which unfiltered medium flows from the inner core 201 to the outer guard 202 through the septum 203, or outside-in flow, in which unfiltered medium flows from the outer perimeter 202 to the inner perimeter 201 through the septum 203.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A filter element having a septum, said septum comprising:
a filter material layer having a pattern of pleats, said pattern repeating a plurality of pleating sequences, wherein
each of said plurality of pleating sequences has a major pleat, a minor pleat, and at least one intermediate pleat arranged in order of pleat height, and
the at least one pleat height of said at least one intermediate pleat is evenly distributed between the pleat height of said minor pleat and the pleat height of said major pleat.

2. The filter element according to claim 1, wherein said filter element has an inner diameter and an outer diameter, and further wherein the pleat height of the major pleat is approximately equal to one-half the difference between said inner diameter and said outer diameter.

3. The filter element according to claim 1, wherein:
each of said major pleat, said minor pleat and said at least one intermediate pleat has a first side, a second side and a tip,
said first side and said second side intersect at said tip to form an angle, and
said angles for said major pleat, said minor pleat and said at least one intermediate pleat are substantially equal.

4. The filter element according to claim 1, further including an inner core and an outer guard, wherein said septum is located between said inner core and said outer guard.

5. The filter element according to claim 4, wherein each of said major pleat, said minor pleat and said at least one intermediate pleat has a base proximate the outer guard.

6. The filter element according to claim 4, wherein a tip of said major pleat of each of said plurality of pleating sequences is in contact with said inner core.

7. The filter element according to claim 1, said septum further comprising an upstream drainage layer.

8. The filter element according to claim 7, wherein said upstream drainage layer is made from an extruded mesh.

9. The filter element according to claim 1, said septum further comprising a downstream drainage layer.

10. The filter element according to claim 9, wherein said upstream drainage layer is made from an extruded mesh.

11. The filter element according to claim 1, said septum further comprising a pre-filter layer.

12. The filter element according to claim 1, said septum further comprising a plurality of spacing elements.

13. The filter element according to claim 1, said filter element further comprising an inner core.

14. The filter element according to claim 13, wherein said inner core and said septum are circular.

15. The filter element according to claim 13, wherein said septum is disposed around said inner core.

16. The filter element according to claim 13, wherein said major pleat has a tip that is in contact with said inner core.

17. The filter element according to claim 1, wherein said second minor pleat of a pleating sequence is adjacent to said major pleat of the following pleating sequence in said pattern.

18. The filter element according to claim 1, said filter element further comprising an outer guard.

19. The filter element according to claim 1, wherein said septum is side-sealed.

20. The filter element according to claim 1, wherein said filter material layer is pre-expanded.

21. The filter element according to claim 1, wherein said major pleat, a first intermediate pleat, and said minor pleat have a pleat height ratio of 3:2:1.

22. The filter element according to claim 1, each of said plurality of pleating sequences including a first intermediate pleat and a second intermediate pleat, wherein said major pleat, said first intermediate pleat, said second intermediate pleat, and said minor pleat have a pleat height ratio of 4:3:2:1.

23. A filter element comprising:
a septum having:
a filter material layer having a pattern of pleats, said pattern repeating a plurality of pleating sequences;
an upstream drainage layer; and
a downstream drainage layer, wherein
said pleating sequences have successively a major pleat, at least one intermediate pleat, and a minor pleat,
each of said at least one intermediate pleat within each of said plurality of pleating sequences has a unique pleat height, and
the pleat height for each of said pleats in each of said plurality of pleating sequences is approximately calculated according to the following formula:
h(i)=h(1)−((i−1)*((h(1)−h(n))/(n−1)));
where
n=the total number of pleats in one of said plurality of pleating sequences,
h(1)=the height of said major pleat, and
h(n)=the height of said minor pleat;
a cylindrical inner core around which said septum is disposed; and
a cylindrical outer guard within which said septum is disposed.

24. The filter element according to claim 23, wherein said major pleat, said at least one intermediate pleat, and said minor pleat have a pleat height ratio of 3:2:1.

25. The filter element according to claim 23, each of said plurality of pleating sequences including a first intermediate pleat and a second intermediate pleat, wherein said major pleat, said first intermediate pleat, said second intermediate pleat, and said minor pleat have a pleat height ratio of 4:3:2:1.

26. The filter element according to claim 23, said major pleat including a tip in contact with said inner core.

27. The filter element according to claim 23, each of said major pleat, said at least one intermediate pleat and said minor pleat including a base in contact with said outer guard.

28. A method of constructing a filter assembly, said method comprising:
pleating a septum to have a pattern of pleats, said pattern repeating a plurality of pleating sequences that have successively a major pleat, at least one intermediate pleat, and a minor pleat, wherein the at least one pleat height of said at least one intermediate pleat is evenly distributed between the pleat height of said minor pleat and said minor pleat;
disposing said septum between an inner core and an outer guard; and
joining an end cap to at least one of said septum, said inner core and said outer guard.

29. The method according to claim 28, further comprising layering a sheet of filter material with a sheet of drainage layer material.

30. The method according to claim 29, further comprising pre-expanding said filter material.

31. The method according to claim 30, further comprising side-sealing said septum.

32. The method of claim 28, wherein said major pleat, said at least one intermediate pleat, and said minor pleat have a pleat height ratio of 3:2:1.

33. The method of claim 28, wherein each of said pleating sequences is pleated to include a first intermediate pleat and a second intermediate pleat, and further wherein said major pleat, said first intermediate pleat, said second intermediate pleat, and said minor pleat have a pleat height ratio of 4:3:2:1.
